(19) United States
(12) Patent Application Publication
(10) Pub. No.: US 2003/0129572 A1
(43) Pub. Date: Jul. 10, 2003

(54) Learning center

(75) Inventors: Eric Thomas Shuler, Piedmont, CA (US); Kathleen Campisano, Danville, CA (US); Stephanie Elias, San Francisco, CA (US); Christa McClintock, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA

(21) Appl. No.: 10/336,239

(22) Filed: Jan. 3, 2003

Related U.S. Application Data
(60) Provisional application No. 60/346,322, filed on Jan. 5, 2002.

(51) Int. Cl. G09G 5/00

(52) U.S. Cl. 434/317

(57) ABSTRACT

Infants and toddlers are introduced to learning through musical sounds and visual stimulation related to different fields of experience. A learning center table includes a hinged book moveable to display a first or a second page. Turning the page selects between a first and a second mode of operation. In one embodiment, the first page illustrates learning indicia such as letters or numbers, with child/toy interaction giving rise to stimulus related primarily to the concepts to be learned. In a second mode, the second page illustrates musical indicia such as instruments and notes, and child/toy interaction gives rise to stimulus related primarily to musical concepts such as timbre, melody, and rhythm.

### CROSS-REFERENCE TO RELATED APPLICATIONS

This patent application claims priority from U.S. provisional patent application No. 60/346,322 filed Jan. 5, 2002. This provisional patent application is hereby incorporated by reference for all purposes.

### BACKGROUND OF THE INVENTION

When learning about a particular subject, it may be helpful for a student to have the assistance of an adult. For example, a young child will often learn to read by looking at a book containing pictures and corresponding words while an adult reads the words. The child follows the words and looks at the associated pictures as the adult reads. The child can study a word within a particular grammatical structure and can gather its meaning, either from the pictures and/or through additional explanation provided by the adult. At any point, the adult can discuss any word or its meaning with the child, or draw the child's attention to a similar word. The adult could also provide a further explanation if needed.

In addition to personalized instruction, instructional aids can assist the child in the learning process. For example, U.S. Pat. No. 5,485,176 describes a system for interacting with a book. The book rests on a housing. A user uses a stylus to select a word or picture in the book. In response, the system can produce an output corresponding to the selected word or picture. For example, after the user selects a picture of an elephant in the book, the system can say the word “elephant,” and can produce a sound associated with an elephant.

While systems of the type described in U.S. Pat. No. 5,485,176 are effective, improvements could be made. For example, for optimal learning, it may be advantageous for a child to be able to tie together different concepts from different areas of experience. Thus association of a particular color with a particular Arabic numeral may aid in a child recognizing and remembering both the numeral and the color.

It would thus be desirable if the presentation of words or pictures to the user was not limited to one particular field of experience. It would also be desirable to provide for an interactive system where a user could select between certain general fields of experience and receive some audio or visual feedback specific to that field of experience. This would make learning more enjoyable and effective. There is a need for improved toys that can induce children including infants and toddlers to play, while at the same time, helping them learn.

Embodiments of the invention address the above problems and other problems, individually and collectively.

### SUMMARY OF THE INVENTION

Using embodiments of the invention, infants and toddlers are introduced to learning through musical sounds and visual stimulation related to different fields of experience. Some embodiments include a toy table having a hinged book moveable to display a first or a second page. Turning the page selects between a first and a second mode of operation. The first page illustrates learning indicia such as letters or numbers, with child/toy interaction giving rise to stimulus related primarily to the concepts to be learned. In a second mode, the second page (which could actually be page 3 of the book) illustrates musical indicia such as instruments and notes, and child/toy interaction gives rise to stimulus related primarily to musical concepts such as timbre, melody, and rhythm.

One embodiment of the invention is directed to a toy comprising: a housing; a toy book on the housing, wherein different pages or sets of pages of the book are operably coupled to switches and wherein a marking on the pages indicate at least first and second operational modes for the toy; a processor operatively coupled to the toy book; a speaker operatively coupled to the processor; and a toy item having a moveable element coupled to the housing, wherein the toy item has an associated switch that is in electrical communication with the processor, and the moveable element of the toy item is adapted to generate a first audio output through the speaker when the moveable element moves in the first operational mode, and wherein the movable element of the toy item is adapted to generate a second audio output through the speaker when the moveable element moves in the second operational mode.

Another embodiment of the invention is directed to an interactive activity table toy comprising: a housing in the form of a table top; a processor in the housing; a speaker operatively coupled to the processor; an electronic book including a switch adapted to indicate to the processor which page is currently being displayed to the user, wherein each page of the book has indicia indicative of a desired operational mode; and one or more toy musical instrument items including having one or more associated switches.

Another embodiment of the invention is directed to a learning table comprising: a housing; legs supporting the housing; a first toy item comprising a toy piano on the housing; a second toy item comprising a lever and a spinner on the housing; and a third toy item comprising a slide switch.

Another embodiment of an interactive activity table toy in accordance with the present invention comprises a housing in the form of a table top, a plurality of switch arrays disposed on the surface of the table top, and a processor located in the housing and operably coupled to the switch arrays. A speaker is located in the housing and is operably coupled to the processor. A first switch array is associated with a book switch, and adapted to indicate to the processor which page is currently being displayed to the user, wherein the displayed page has indicia indicative of a desired learning mode. A second array of switches is associated with switches configured in the form of one or more musical instruments; and optionally additional switch arrays are associated with additional play elements; wherein the audio signal generated by the processor corresponds to the indicia displayed on the book switches.

An embodiment of a method of educational play in accordance with the present invention comprises providing a housing, providing a toy book on the housing, and providing movable elements associated with the book. Switches are provided operably coupled to the moveable elements, a processor is provided operably coupled to the switches, and a speaker is provided operably coupled to the processor. One or more toy elements is provided, each having one or more moveable elements coupled to the housing, and one of the moveable elements is moved to generate an audio response.

An embodiment of a method of operating a toy in accordance with the present invention comprises providing a processor in electronic communication with a page of a book, and turning the book page to cause the processor to switch between a first mode of operation and a second mode of operation.

These and other embodiments are described in further detail below with reference to the Figures and the Detailed Description.

### BRIEF DESCRIPTION OF THE DRAWINGS

FIG. 1(a) illustrates a top perspective view of a toy according to an embodiment of the invention.

FIG. 1(b) shows a schematic illustration of a book with a spine switch.

FIG. 2 illustrates an underside view of the toy shown in FIG. 1(a).

FIG. 3A shows a plan view of a first side of the center page of a book displayed to the child when the toy is in a first learning mode.

FIG. 3B shows a plan view of a second side of the center page of a book displayed to the child when the toy is in the second music mode.

FIG. 4A illustrates a first circuit diagram portion of a circuit that is used in the toy of FIG. 1(a).

FIG. 4B illustrates a second circuit diagram portion.

FIG. 5 illustrates a plan view of a center page of an alternative embodiment of a book.

FIGS. 6(a) and 6(b) show an infant gym embodiment with the book shown in FIG. 5.

### DETAILED DESCRIPTION OF THE INVENTION

Children such as infants and toddlers are introduced to learning through musical sounds and visual stimulation related to different fields of experience. In one embodiment, a learning center table includes a hinged book moveable to display a first or a second page. Turning the pages allows a child to select between at least a first and a second mode of operation. For example, when displayed to the child, the first page may illustrate learning indicia such as letters or numbers, with child/toy interaction giving rise to stimulus related primarily to the concepts to be learned. This may be a “learn mode”. The second page (which could be the third page of the book) may illustrate musical indicia such as instruments and notes, with child/toy interaction giving rise to stimulus related primarily to musical concepts such as timbre, melody, and rhythm. This may be a “music mode”.

The “learn mode” can include any type of instruction. For example, it may include declaratory instruction, quizzing, and/or kinesthetic instruction. In declaratory instruction, names or facts about letters, objects (e.g., animals, people), shapes, etc. can be produced in response to a child's interaction with one or more toy items in the table. In a quizzing instruction mode, the child may be prompted to answer a question. For example, the learning table may ask the child “can you find the red square”? In a kinesthetic mode, lights in the learning table may flash and a child may be asked to push the light thereby correlating a visual stimulus with physical activity. Any of these instructional modes can be preprogrammed into a memory associated with the toy.

Although the “music mode” and the “learn mode” may be exemplary first and second operational modes, the operational modes may be defined in any suitable manner. For example, in other embodiments, a first, second, and third operational modes may relate to modes that may teach about numbers, letters, and phonics, respectively.

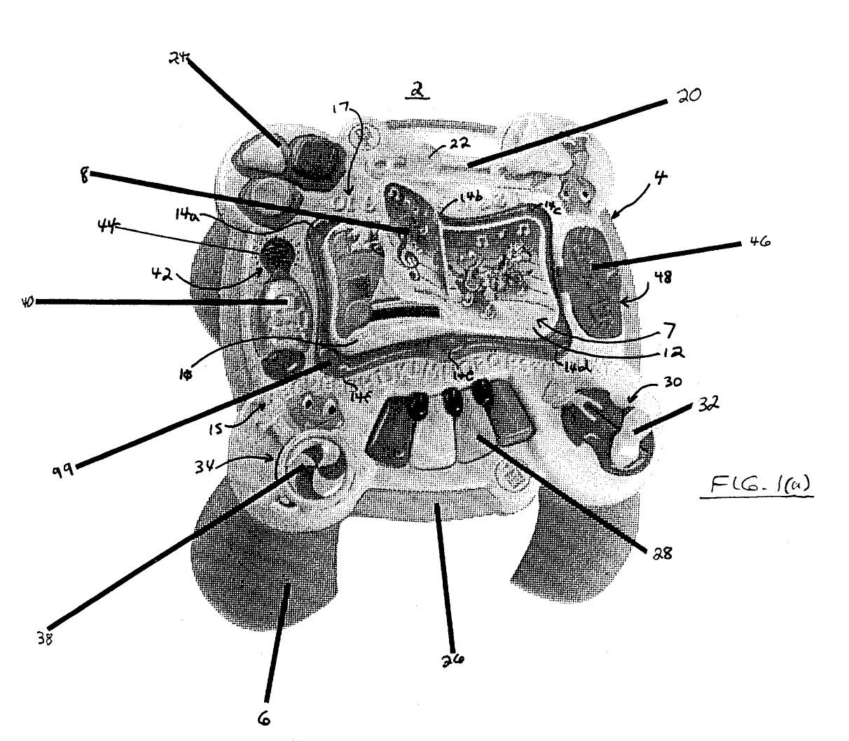

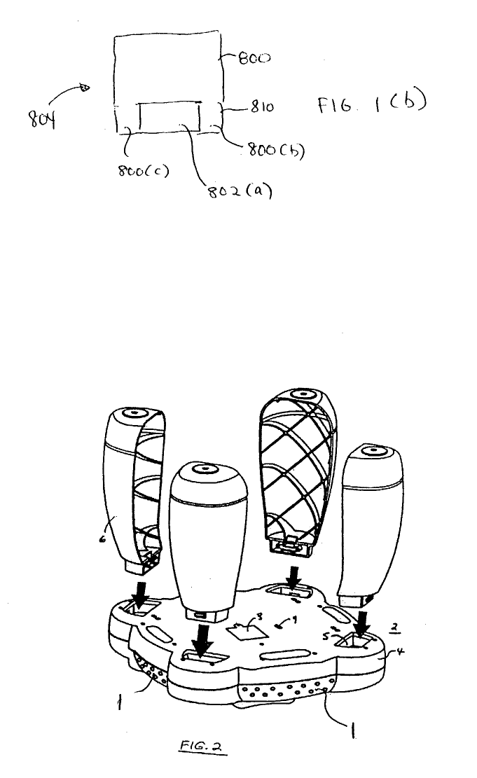

FIG. 1(a) shows a toy according to one embodiment of the present invention. Toy 2 comprises platform or table portion 4 including a housing (e.g., a plastic housing) supported by four legs 6. The housing may house the various electronics that are used to operate the toy 2.

In some embodiments, the toy 2 includes an electronic book that has pages. The pages of the book can be made of paper, hard plastic, or soft plastic. The pages can be used as an operational mode switch to change the operational mode of the toy 2. This is more advantageous than, for example, a slide switch that is used to change the operational mode of a toy. When specific pages of an electronic book are displayed to the user, the pages can display a “theme” under which the toy operates. For example, as shown below, two themes can be a “numbers and letters” theme and a “music” theme. The entire look and feel of the toy can change, because images on the pages of the book correspond to the particular theme associated with the particular operational mode that the toy is currently in. Unlike toys with bare slide switches, using a book as an operational mode selection device makes the toys according to embodiments of the invention more fun and engaging.

Referring to FIG. 1(a), a book 7 is on the housing and includes a center page 8 hingeably secured between open book portions (pages) 10 and 12. In this example, the book portions 10, 12 may include pages with images on them. The book 7 includes a spine that houses electrical switches. When a page of the book 7 is turned, a predetermined number of the switches activate to inform a processor inside of the housing that a particular page, or set of pages is being displayed to the user. As explained in further detail below, turning the pages of the book 7 and displaying different pages of the book 7 to the child causes the toy 2 to be in a different operational mode.

In some embodiments, switches may be associated with the spine of the book 7 to indicate to a processor which page or pages are currently being displayed to the child. For example, FIG. 1(b) shows a side view of a book 804 with a segmented spine 810 and a page 800. When the page 800 is turned, spine portions 810(b) and 810(c) may turn with the page 800, while spine portion 802(a) remains stationary. A switch in the spine 810 can open or close depending on the particular page of the book 804 being displayed. Various other page detection mechanisms are known in the art and need not be described in detail here.

Referring again to FIG. 1(a), lights 14a, 14b, 14c, 14d, and 14e surround book 7. The lights are present under a translucent border structure 99 surrounding the book 7. These lights 14a, 14b, 14c, 14d, and 14e can flash in sequence, randomly, or all at once in embodiments of the invention. Raised alphabet 14 is located below book 7. Raised numerals 17 are located above book 7. The raised alphabet 14 and the raised numerals 17 in this example, show the numbers 1-10 and the letters A-Z.

A number of colorful, toy items including moveable elements are arranged on the housing of the toy 2 around book 7. Each toy item and each moveable element may have one or more electrical switches associated with it. When activated, the one or more electrical switches can inform a processor inside of the housing of the toy 2 to produce a predetermined sound associated with the moveable element or the toy item. Various specific audio scripts for the toy can be found in U.S. Patent Application No. 60/346,322 filed Jan. 5, 2002, which is herein incorporated by reference in its entirety.

Referring to FIG. 1(a), trombone 20 having knob 22 slideable from left to right is positioned above book 7. When a child slides the knob 22, the sound of a trombone is made in a music mode and the counting of the numbers 1-10 sounds in the learning mode. Depressible drums 24 of different colors and shapes are positioned to the left of trombone 20. When a child presses the drums 24, the sound of drums are produced in the music mode and the colors of the drums are stated by the toy 2 in the learning mode. A piano keyboard 26 having keys 28 of different colors, is positioned below book 7. When a child presses the keys 28 of the keyboard 26, the toy makes piano sounds in the music mode and says the colors of the piano keys in the learning mode. Cello 30 having vertically moveable slide 32 (in the form of a bridge) is positioned to the right of keyboard 26. When a child slides slide of the cello 30, the toy 2 makes a cello sound in the music mode, and says positions such as up, down, high, and low in the learn mode. Banjo 34 having spring-biased neck 36 and spinner 38 is positioned to the left of keyboard 26. When a child pulls down on the neck 36, the toy 2 makes a banjo sound in the music mode and says “lights on”, “lights off” in the learning mode. Also, the various lights 14a, 14b, 14c, 14d will light up or not light up depending on whether “lights on” is recited or “lights off” is recited by the toy 2.

Rotatable transparent maraca 40 containing colored beads is positioned to the left of book 7. Handle 42 of maraca 40 includes speaker port 44. When a child spins the maraca 40, a song such as the alphabet song can be played in the learn mode, and the sound of a xylophone or maraca can sound in the music mode. Hinged music box door 46 concealing recessed storage niche 48 is positioned on the right of book 7. A young user or adult may place a bright moveable object such as a block or bead into niche 48 hidden from the child's view, but which upon opening of door 46 becomes visible to the user. In the learn mode, opening and closing the door 46 causes the toy 2 to say words such as hello, goodbye, open or close. In a music mode, a song may be played when the child opens or closes the door 46.

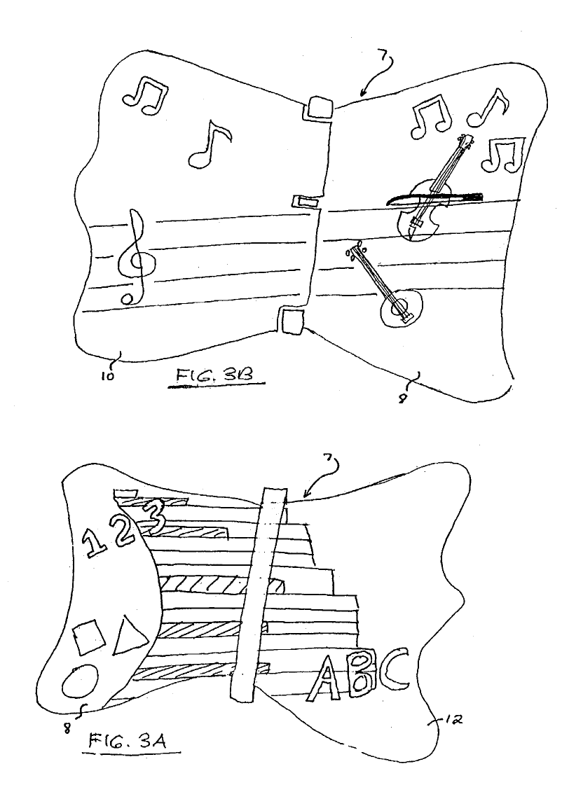

FIG. 2 illustrates an underside view of the toy table of FIG. 1(a). Specifically, legs 6 having projecting tabs 6a are inserted into recesses 5 located in table underside 2a, thereby permitting legs 6 to be secured into table portion 4. The toy 2 may be used with the legs attached, or may be used as a tablet without the legs attached. For example, the table portion 4 on the floor can be used without the legs. Alternatively, the table portion 4 could be put on an easel or other stand. Table underside 2a also features battery chamber cover 3 and on/off switch 9. Side grips 1 allow a person to easily grip and carry the toy 2.

Advantageously, the toy 2 can be used by a child when the child is an infant and when the child is a toddler. For example, a crawling infant can play with the toy 2 when the table portion 4 is on the floor, and is used without legs. A walking toddler can use the toy 2 when the table portion 4 is on the legs 6.

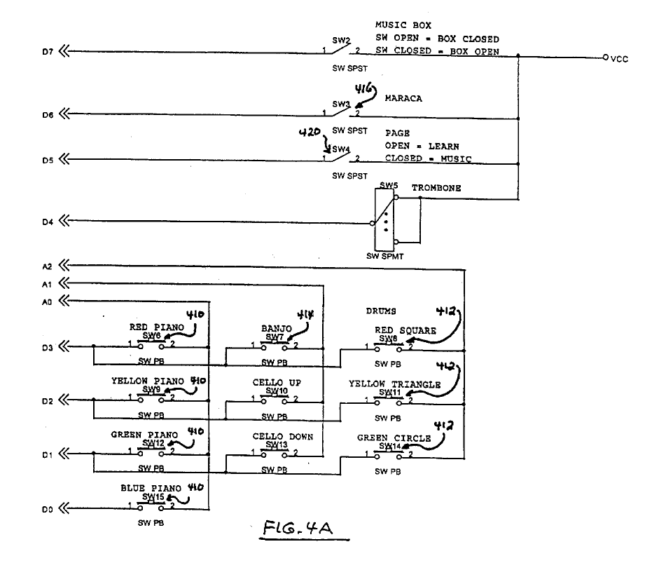

A further exemplary description of the function of the toy is as follows. After sliding on/off switch 9 to the on position, the user adjusts book 7 to expose one of the two sides of hinged center page 8, and thereby select a mode of operation for the toy. FIG. 3A shows a plan view of center page 8 of toy 2 turned to a first learning mode. FIG. 3B shows a plan view of center page 8 of toy 2 turned to a second music mode.

Where hinged center page 8 is turned to be in contact with left hand open book portion 10, an image illustrating learning concepts such as numbers and letters is displayed. This orientation of hinged center page 8 places the toy 2 in a first, learning mode, wherein manipulation of the moveable elements produces audio and visual stimulation that is oriented toward the learned concepts. For example, in the first, learning mode, sliding of the trombone knob will result in speaker 44 emitting an audio signal of a voice counting from one to ten.

Where the user desires to change operational modes, hinged center page 8 is turned to rest against right hand side portion (page) 12 of book 7. In this second, musical mode, manipulation of the moveable elements produces audio and visual stimulation oriented toward musical concepts. For example, in the second, musical mode, sliding of the trombone knob 22 results in speaker 44 emitting the sound of a theme song played by a trombone.

TABLE 1 below summarizes user inputs to the moveable elements, and corresponding outputs for the learning and musical modes:

TABLE 1

| TOY | MOVEABLE | | MUSIC |
|---|---|---|---|
| ITEM | ELEMENT | LEARN MODE | MODE |
| cello | slide up or down | slide position: | cello themes |
| | | up/down/high/low | |
| piano | press key | key colors: | piano themes |
| | | red/yellow/green/blue | |
| banjo | press neck down | lights on, then off | banjo themes |
| maraca | spin body | alphabet song | xylophone |
| | | | themes |
| drums | press down | drum color and shape: | drum theme |
| | | green/circle/red/square/ | |
| | | yellow/triangle | |
| trombone | slide left or right | count to 10 | trombone |
| | | | theme |
| music box | open or close door | door position: | vocal theme |
| door | | hello/goodbye/open/close | |

The foregoing Table lists a number of examples of toy items and moveable elements. Embodiments of the invention are not limited to these specific examples. Other toy items and associated movable elements may include, for example, toy animals such as cats, dogs, cows, etc. with movable tails or depressible body parts, toy household objects such as phones with depressible buttons, toy letters and numbers that are in the form of depressible buttons, etc.

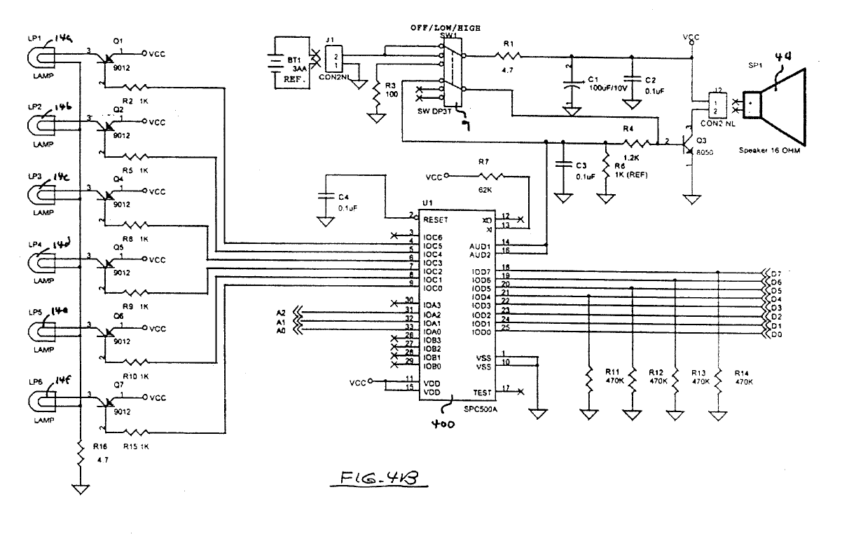

Operation of the learning table in either music or learning mode is controlled by electronic circuitry. FIG. 4A illustrates a first circuit diagram portion of the toy 2, and FIG. 4B illustrates a second circuit diagram portion of the toy 2. Operation is governed by processor 400, which is electronically linked through various circuit components to lights 14a-f, speaker 44, and various switch arrays. One example of such a switch array is the book switch 420 that is physically operated by moving the center page of the book. A second example of a switch array is the array of switches 410 in physical communication with piano keys 28. Another example of such a switch array is the array of switches 412 that are in physical communication with drums 24. Other switches include spinner switch 414 in communication with the neck of banjo 34, and roller switch 416 in communication with maraca 40. Depending upon the position of center page 8, activation of the book switch 420 will result in various toy components producing a particular output.

The processor 400 may be preprogrammed with computer code for any suitable audio and with instructions for performing any of the toy functions mentioned herein. A separate memory chip (not shown) could also be coupled to the processor 400 and the memory chip may include computer code for operating instructions or audio for the toy.

A speech synthesizer can be on the same or different chip as the processor. Suitable speech synthesizer chips are commercially available. An exemplary speech synthesizer chip is an SPDS 106 chip, which is commercially available.

As just described, manipulation of various moveable elements of the toy can introduce the infant or toddler to a number of key developmental concepts. For example, the letters of the entire alphabet are displayed in raised figures on the table top, and spinning the maraca while in the learning mode will result in an audio recitation of the alphabet song (“the ABC song”), and hence will result in the child learning the alphabet.

The toy can also introduce a young user to the key developmental concepts of numbers and counting. For example, numbers 1-10 are displayed in raised figures on the table top, and sliding of the trombone knob results in an audio recitation of the numbers 1-10 so a child can learn to count from 1 to 10.

The toy can further introduce a young user to the key developmental concepts of shapes and colors. For example, the drum kit comprises a red square-shaped drum, a green circular drum, and a yellow triangle-shaped drum. In the learning mode, pressing any of these drums results in an audio recitation of drum shape and color.

The toy can also introduce a young user to the key developmental concepts of spatial positioning. For example, the cello slide in the form of a bridge is normally biased to rest at the midpoint of the instrument. In learning mode, biasing the slide upward results in the audio recitation of the words “up” or “high”, accompanied by a higher-pitched cello note. Biasing the slide downward results in the audio recitation of the corresponding words “down” or “low”, accompanied by a lower-pitched cello note.

The above-listed specific developmental concepts imparted to a young user of the toy are in addition to the more general concepts of cause and effect, gross and fine motor skills and musical awareness that are promoted.

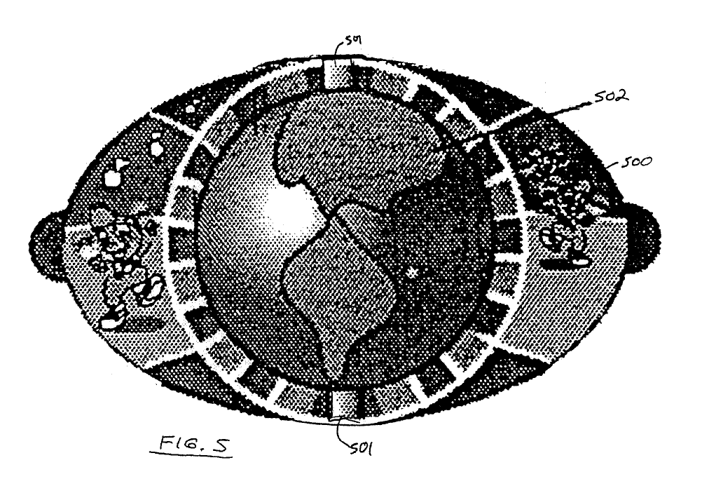

Those skilled in the art will appreciate that various adaptations and modifications of the above-described embodiments can be configured without departing from the scope and spirit of the inventions. Thus while the specific embodiment described above features a solid hinged center page, this is not required by the present invention. FIG. 5 shows one alternative electronic book embodiment, wherein page 500 in the shape of a crescent secured by hinge 501 flanks fixed circular hemisphere 502, here showing a simplified portion of the earth. The fixed circular hemisphere 502 may be a globe that can rotate. Flipping of crescent-shaped center page 500 back and forth about hemisphere 502 switches a toy between different modes of operation.

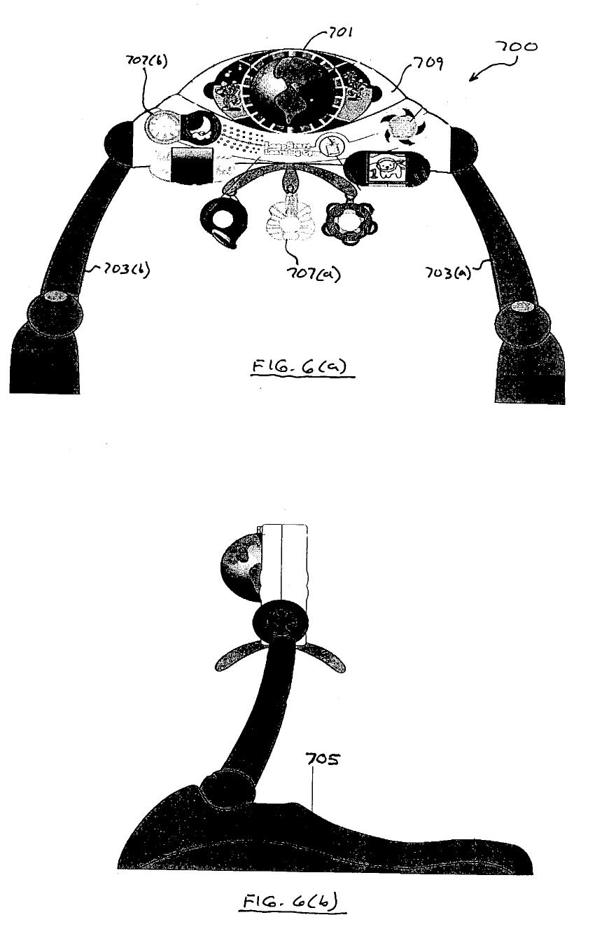

As shown in FIG. 6(a), a book 701 of the type shown in FIG. 5 can be used in an infant gym 700. The infant gym includes a housing 709 that is supported by two legs 703(a), 703(b) which are in turn supported by a base 705. Various hanging toy items 707(a), 707(b) are directly on or hanging (e.g., a hanging mobile) from the housing 709. An infant may lie on his back, under the housing 709 and touch the hanging toy items 707(a) to produce sounds from the toy 2. Alternatively, a child sitting up may play with the toy items 707(b) on the housing to produce sounds from the toy 2.

A parent or a child may turn the pages of the book 701 to change the operational mode of the toy by turning the pages of the book 701. In this embodiment, there may also be a learning operational mode and a music operational mode. In this embodiment, the learning mode may include language instruction.

While the embodiments illustrated and described in the preceding figures relate to a toy operable between different learning and musical modes, the present invention is not limited to that particular examples described herein. Alternative embodiments could utilize an activity center operable between a learning mode and a second mode relevant to a different field of experience. Examples of such a different field of experience includes but are not limited to farm animals, zoo animals, celestial objects, motor vehicles, fruits, sports, fish, birds, and plants.

Moreover one or more features of embodiments of the invention may be combined with any other feature without departing from the scope and spirit of the invention. For example, although the above description focuses upon a device operable between a learning mode focusing upon learning concepts and music, the present invention is not limited to this particular embodiment. In alternative embodiments, concepts of different fields of experience, such as types of animals and different motor vehicles could be linked by audio/visual cues.

And while the embodiments shown and described above in connection with FIGS. 1-4B utilize two operational modes that are selected by flipping a single page, the present invention is not limited to this particular number of operational modes. In accordance with alternative embodiments, a toy could include three or more modes of operation selectable by turning two or more pages.

Furthermore, while the embodiments shown and described above in connection with FIGS. 1-4B utilize two operational modes that are selected by flipping a page, the present invention is not limited to this particular mechanism for switching between operational modes. In accordance with alternative embodiments, a toy could include one or more indicia positioned on or outside of the book, with operational mode selectable by manipulating either the indicia themselves, or a moveable element associated with the indicia, such as a push button coupled with a switch.

The toy according to embodiments of the present invention can optionally include a slot (not shown) for a transferable information storage medium (not shown) that is operatively coupled to the processor and memory unit. The slot can be cooperatively structured to receive the transferable storage medium in a removable manner. Any suitable transferable storage medium can be employed in the toy including, but not limited to, a data cartridge (e.g., a flash memory cartridge), a disk, a tape or a memory stick. The transferable information storage medium can be used to provide code for new operating modes or new audio data (e.g., new songs) to the toy. The transferable information storage medium may be purchased at a store, or may be created at the user's site by downloading new content from a personal computer or from the Internet.

The toy can also form part of a system that provides the toy with new content if desired. For example, in some embodiments, a linker device can be used to transfer data (e.g., new audio data or code for new operating modes) between the ball and a computer (e.g., an Internet-enabled personal computer or server computer). The linker device can be any suitable linker device known to one skilled in the art, such as a wireless transceiver (e.g., a radio frequency [RF] transceiver or an infra-red [IR] transceiver) or a data port (e.g., a Universal Serial Bus [USB] data port). Such a data port enables a user to transfer data to, and from, the toy through a physical connection (e.g., a data cable) among the toy and a client PC or the Internet. The use of the linker device creates an Internet-enabled toy. Additional details regarding such Internet-enabled embodiments can be found in U.S. patent application Ser. No. 09/632,424, filed on Aug. 4, 2000. This U.S. patent application is herein incorporated by reference in its entirety for all purposes.

Based upon the above description, it is to be understood that, within the scope of the appended claims, the invention may be practiced other than as specifically described herein. Moreover, one or more features of one or more embodiments may be combined in any suitable manner without departing from the spirit and scope of the invention.

What is claimed is:

1. A toy comprising:
a housing;
a toy book on the housing, wherein different pages or sets of pages of the book are operably coupled to switches and wherein a marking on the pages indicate at least first and second operational modes for the toy;
a processor operatively coupled to the toy book;
a speaker operatively coupled to the processor; and
a toy item having a moveable element coupled to the housing, wherein the toy item has an associated switch that is in electrical communication with the processor, and the moveable element of the toy item is adapted to generate a first audio output through the speaker when the moveable element moves in the first operational mode, and wherein the movable element of the toy item is adapted to generate a second audio output through the speaker when the moveable element moves in the second operational mode.

2. The toy of claim 1
wherein the toy item is in the shape of a musical instrument,
wherein the moveable element is in the shape of a moveable part of the musical instrument, and
wherein the movement of the moveable element produces a sound of a single note from the musical instrument in the first operational mode, and produces a sound of other than a single note from the musical instrument in the second operational mode.

3. The toy of claim 2 wherein movement of the moveable element in the second operational mode produces a sound selected from the group consisting of an oral recitation of a number, an oral recitation of a word, and a series of musical notes.

4. The toy of claim 1 wherein the toy further comprises lights, and wherein the moving the moveable element activates the lights and generates a visual stimulus.

5. The toy of claim 4 wherein the visual stimulus is different depending upon the operational mode.

6. The toy of claim 1 wherein:
the toy item is in the shape of a niche covered by a hinged door;
the moveable element is the hinged door; and
at least one of opening and closing of the door produces an audio stimulus.

7. The toy of claim 6 wherein an audio stimulus is different in the first and second modes of operation.

8. The toy of claim 1 wherein the toy book further comprises an indicia operably coupled to the switch.

9. An interactive activity table toy comprising:
a housing in the form of a table top;
a processor in the housing;
a speaker operatively coupled to the processor;
an electronic book including a switch adapted to indicate to the processor which page is currently being displayed to the user, wherein each page of the book has indicia indicative of a desired operational mode; and
one or more toy musical instrument items including having one or more associated switches.

10. The toy of claim 9 wherein the indicia on the displayed page are letters, and the audio output generated by movement of the one or more musical instruments comprises audio relating to letters, numbers, or colors.

11. The toy of claim 9 wherein the indicia on the displayed page are numbers, and the audio output comprises audio relating to numbers.

12. The toy of claim 9 wherein the indicia on the displayed page are notes, and the audio output comprises music.

13. The toy of claim 9 wherein the indicia on the displayed page are colors, and wherein the audio output comprises audio relating to colors.

14. The toy of claim 9 further comprising a spinner on the housing.

15. The toy of claim 9 further comprising a roller on the housing.

16. The toy of claim 9 wherein the table has removable legs that are replaceable with an easel support.

17. A learning table comprising:
a housing;
legs supporting the housing;
a first toy item comprising a toy piano on the housing;
a second toy item comprising a lever and a spinner on the housing; and
a third toy item comprising a slide switch.

18. The learning table of claim 17 wherein the learning table further comprises:
a fourth toy item comprising a bead-filled roller; and
a fifth toy item comprising depressible buttons with distinctive shapes and colors.

19. The learning table of claim 17 wherein further comprising a mode switch to change the operational mode of the learning table.

20. The learning table of claim 19 wherein the mode switch is in the form of a slide switch.

21. The learning table of claim 19 wherein the mode switch is in the form of an electronic book.

22. An interactive activity table toy comprising:
a) a housing in the form of a table top;
b) a plurality of switch arrays disposed on the surface of the table top;
c) a processor located in the housing and operably coupled to the switch arrays;
d) a speaker located in the housing and operably coupled to the processor;
e) a first switch array associated with a book switch, and adapted to indicate to the processor which page is currently being displayed to the user, wherein the displayed page has indicia indicative of a desired learning mode;
f) a second array of switches associated with switches configured in the form of one or more musical instruments; and
g) optionally additional switch arrays associated with additional play elements; wherein the audio signal generated by the processor corresponds to the indicia displayed on the book switches.

23. The toy of claim 22 wherein the indicia on the displayed page are letters and the audio signal generated at the interactive stations teaches letters.

24. The toy of claim 22 wherein the indicia on the displayed page are numbers and the audio signal generated at the interactive stations teaches numbers.

25. The toy of claim 22 wherein the indicia on the displayed page are notes and the audio signal generated at the interactive stations teaches music.

26. The toy of claim 22 wherein the indicia on the displayed page are colors and the audio signal generated at the interactive stations teaches colors.

27. The toy of claim 22 further comprising a spin switch.

28. The toy of claim 22 further comprising a roller switch.

29. The toy of claim 22 wherein the table has removable legs that are replaceable with an easel support.

30. A method of educational play comprising,
providing a housing;
providing a toy book on the housing;
providing movable elements associated with the book;
providing switches operably coupled to the moveable elements;
providing a processor operably coupled to the switches;
providing a speaker operably coupled to the processor;
providing one or more toy elements each having one or more moveable elements coupled to the housing; and
moving one of the moveable elements to generate an audio response.

31. A method of operating a toy comprising:
providing a processor in electronic communication with a page of a book; and
turning the book page to cause the processor to switch between a first mode of operation and a second mode of operation.

32. The method of claim 31 wherein the first mode of operation results in production of a first audio stimulus in response to a physical movement of a toy item, and the second mode of operation results in production of a second audio stimulus in response to the physical movement of the toy item.

33. The method of claim 31 wherein the physical movement comprises moving the toy item in the shape of a musical instrument to produce a tone of the musical instrument in the first operating mode, and moving the toy item to produce other than a tone of the musical instrument in the second operating mode.

34. The method of claim 33 wherein production of other than the tone of a musical instrument in the second mode of operation comprises producing a word, a letter, and a non-musical sound.

35. The method of claim 31 wherein the physical movement comprises at least one of opening and closing the toy item in the shape of a door overlying a recess to produce a musical sound in the first operating mode, and to produce other than a musical sound in the second operating mode.
